(19) United States
(12) Patent Application Publication
(10) Pub. No.: US 2006/0246913 A1
(43) Pub. Date: Nov. 2, 2006

(54) Method for handling propagation delay in a wireless communication system

(76) Inventors: Lawrence J. Merboth, Bridgewater, NJ (US); Paul Anthony Polakos, Marlboro, NJ (US); Stephen A. Wilkus, Lincroft, NJ (US); Henry Hui Ye, Ledgewood, NJ (US); Lily H. Zhu, Parsippany, NJ (US)

Correspondence Address: HARNESS, DICKEY & PIERCE, P.L.C., P.O. BOX 8910, RESTON, VA, 20195, US

(21) Appl. No.: 11/115,169

(22) Filed: Apr. 27, 2005

(51) Int. Cl. H04Q 7/20; H04M 1/00

(52) U.S. Cl. 455/445; 455/427

(57) ABSTRACT

In one embodiment of the method, a base station is configured to divide a coverage area of the base station into sub-coverage areas. Each sub-coverage area has a smaller range of round trip propagation delays than a range of round trip propagation delays for the coverage area of the base station. Each sub-coverage area may have a different range of round trip propagation delays.

### BACKGROUND OF THE INVENTION

In regular cellular communication systems the mobile stations (MS) communicate with base stations (BS) that are within a few kilometers to a couple of hundred kilometers distant. In this case the propagation delay, which is defined as the delay encountered by the signal traveling from BS to MS or, equivalently, the delay encountered by the signal traveling from MS to BS, is within a corresponding range that is proportional to the distance between the MS and BS, typically a few microseconds to a few hundred microseconds.

However, in some certain applications, the signals traveling from BS to MS or from MS to BS can encounter extremely long propagation delay. For example, some service providers are interested in using geosynchronous satellites to communicate between mobile stations and base stations that may be half a continent away. This can happen when a MS is in an area where there is no BS deployed. In this case, the service providers can use satellite(s) to relay the signals between the MS and a BS that can be thousands of kilometers away. As a result, the absolute propagation delay of the signal traveling between MS and BS, through the satellite is, extremely long since the distance the signal travels is on the order of tens of millions of meters. In addition, the range of the differential delay, i.e., the difference between the upper bound of the propagation delay and the lower bound of the propagation delay, is also very large. This is because the distance between a MS on the earth and a satellite in space can vary significantly (on the order of thousands of kilometers) depending on the physical location of that MS.

The current CDMA BS products appear unable to support such extremely long propagation delays due the following:
general base band modem processors (implemented as an application specific integrated circuit (ASIC), field programmable gate array (FPGA), or digital signal processor (DSP)) in the BS cannot demodulate signals with extremely long propagation delay, and
some call processing timing requirements may be violated.

Next, how the MS and the BS are synchronized in a conventional system will be described. The BS uses prescribed pseudo random PN codes (such as a long code and a short code) to scramble its transmitted signals. The MS can then detect the states of those PN codes at the MS receiver. In addition, the MS also uses some certain pseudo random PN codes, which could be different from what the BS uses, with states aligned to the detected BS PN code states to scramble its outputs. The BS receiver can use the received signals from the MS to detect the states of the MS's PN codes. The difference between the BS transmitter's PN code states and the detected MS's PN code states at the BS indicates the round trip propagation delay between the MS and BS.

The BS baseband processor is in general implemented in ASIC/FPGA/DSP devices. For example purposes, implementation as an ASIC device will be described. In order to demodulate the signals sent from the MS, the BS ASIC needs to align the PN code states to the received signals appropriately. This can be described mathematically by the following equations.

Assume the BS received signal is R(t), then
R(t)=S(t−d)*PN(t−2d)+N(t), (1)
where S(t) is any given mobile's signal, PN(t) is the scrambling code (e.g., PN code(s)) used by the MS, N(t) is the total noise including all other mobiles' valid signals (that are interference to this mobile) and all other noises, and d is the one way delay between the MS and BS.

Notice that the PN code states are delayed by “2d” because the mobile uses the received signals from the BS to determine its PN code states, and the signals received by the MS are delayed by “d”. In order to remove the PN codes, the BS needs to multiple R(t) by PN(t−2d) to get the original transmitted signal from MS, i.e.,

$$\begin{matrix}R ( t ) * PN ( t - 2 d ) = S ( t - d ) * PN ( t - 2 d ) * PN ( t - 2 d ) + \\ N ( t ) * PN ( t - 2 d ) \\ = S ( t - d ) + N ( t ) * PN ( t - 2 d )\end{matrix} \qquad ( 2 )$$

The above equation implies that the BS needs to use PN(t−2d) at the time t where 2d is the round trip delay (round trip delay is the sum of the delay from BS to MS and the delay from MS to BS). The value of the round trip delay 2d relates to the distance between the MS and the BS. The conventional BS in cellular communications can support communications between MS and BS that are up to 100 to 200 kilometers apart. In other words, it means that
0<=2d<=M (3)
where M is on the order of 0.66 ms (corresponding to 100 kilometers) to 1.33 ms (corresponding to 200 kilometers).

Equation (2) implies that the ASIC needs to generate PN(t−2d) at time t. This should be easily achievable if the ASIC only needs to demodulate the signal from a single MS. However, most state of art ASIC solutions in a BS handle signals from multiple mobile stations. In addition, the BS may have multiple arrays receiving from each MS and therefore requires multiple rake finger processing. This means the ASIC needs to generate I*J PN code states at time t if the ASIC is to demodulate signals received from I mobile stations and an average of J rake fingers are assigned to each MS. Therefore, an alternative method that is widely used in BS ASIC solutions is to store the raw received data R(t), where R(t) is the composite received signals from all the mobiles plus noises. This is because the BS ASIC can remove any mobile's PN code to obtain that mobile's original transmitted signal s(t) by performing the following operation at the time t:

$$\begin{matrix}R ( t - M + 2 d ) * PN ( t - M ) = S ( t - M + d ) * PN ( t - M + \\ 2 d - 2 d ) * PN ( t - M ) + \\ N ( t - M + 2 d ) * PN ( t - M ) \\ = S ( t - M + d ) + N ( t - M + 2 d ) * \\ PN ( t - M )\end{matrix} \qquad ( 4 )$$

Since 0<=2d<=M, equation (4) implies that BS ASIC needs to store all the received signals R(u) for t−M<=u<=t at time t. This usually requires only a few megabits or less memory space which can be readily implemented by the current generation of ASIC devices. Note that there is no need to store PN code sequences since PN(t−M) can be generated at time t.

### SUMMARY OF THE INVENTION

The present invention provides methodologies for handling propagation delay.

In one embodiment, a base station is configured to divide a coverage area of the base station into sub-coverage areas. Each sub-coverage area has a smaller range of round trip propagation delays than a range of round trip propagation delays for the coverage area of the base station. Each sub-coverage area may have a different range of round trip propagation delays. For example, the different ranges of round trip propagation delays may be non-overlapping. In one embodiment, the sub-coverage areas are concentric.

In one embodiment, the configuring step assigns a different processing device of the base station to each sub-coverage area. For example, each processing device may be one of an ASIC, FPGA and a DSP.

In one embodiment, each processing device includes a receiver and the configuring step skews the reference time of each receiver so that each processing device sees a different range of round trip propagation delays. For example, the configuring step may skew the reference time of at least one receiver by shifting a PN sequence of the receiver.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an example of a wireless communication system having long round trip propagation delays; and

FIG. 2 illustrates an example of dividing a coverage area into rings and assigning an ASIC at a base station to each ring.

### DETAILED DESCRIPTION OF THE EMBODIMENTS

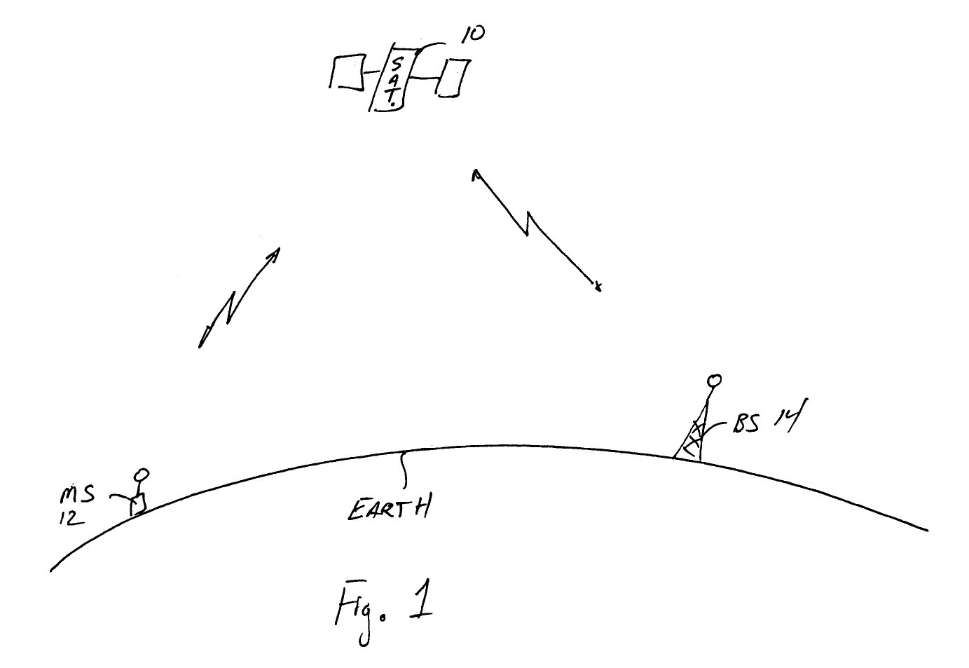

As mentioned earlier, in some certain applications, the round trip propagation delay can be extremely long, on the order of many hundreds of milliseconds. For example, as shown in FIG. 1 some service providers are interested in using geosynchronous satellites 10 to communicate between mobile stations, such as mobile station 12, and base stations, such as base station 14, that may be half a continent away. This can happen when a MS is in an area where there is no BS deployed. In this case, the service providers can use satellite(s) to relay the signals between the MS and a BS that may be thousands of kilometers away. As a result, the round trip propagation delay is extremely long. This delay consists of the propagation delay from the base station to the satellite, plus the delay from the satellite to the mobile station, plus the return trip from the mobile station to the satellite and again the delay from the satellite back to the base station. For example, for some satellites the total round trip propagation delay may be around 500 ms.

While 500 ms becomes the upper bound of the propagation delay in this example, it should be noted that the lower bound of the propagation delay is also quite large. Also, it will be appreciated that this upper bound is merely an example, and the present invention is not limited to this example.

We use T_low to represent the lower bound propagation delay for this kind of application and T_high to represent the upper bound propagation delay, such that:
T_low <=2d<=T_high (5)
where 2d is the actual round trip propagation delay. While both T_low and T_high are very large (e.g., in the order of 500 ms), the differential delay, T_high−T_low, can be also quite large (e.g., in the order of 10 ms).

A straightforward extension of the solution in the current art as described in equation (4) would be performed at the time t as follows:
R(t−T_{—}high+2d)*PN(t−T_{—}high) (6)

This would require the ASIC to store R(u) for all u such that t-T_high+T_low<=u<=t at the time t. However, this requires outrageous amount of storage in ASIC and would introduce unacceptable ASIC cost and power consumption. In the following we propose an efficient method to support this kind of application where extremely long propagation delays are encountered.

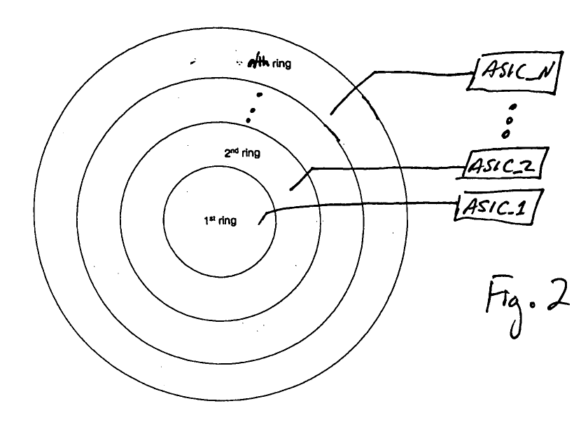

Recall that the current BS ASIC products generally support propagation delay in the range of 0 to M where M is on the order of 0.66 ms to 1.33 ms as shown in equation (3). First, without loss of generality, assume T_low=L*M for some integer L and T_high=(L+N)*M for some integer N. Alternatively, the value for T_high may be changed and/or the value for T_low may be changed so that both are multiples of M. With the understanding that (1) L*M and (L+N)*M are very large (e.g., on the order of 500 ms), (2) T_high−T_low=N*M is large (e.g., on the order of 10 ms), and (3) most ASICs store the received data for a duration of M, the coverage area for a long propagation delay system element (e.g., the coverage area of the satellite 10 in FIG. 1) is divided into N geographic rings. For example in one embodiment, the coverage area is divided into N concentric rings as shown in FIG. 2 such that the mobile stations within each ring have their round trip delays 2d satisfy the following condition:
First ring: LM<=2d<(L+1)M,
Second ring: (L+1)*M<=2d<(L+2)*M
. . . . . .
The N-th ring: (L+N−1)*M<=2d<=(L+N)*M (7)

FIG. 2 illustrates geographic rings projected upon the earth with lines corresponding to points equidistant from the satellite to the curved surface of the earth.

As shown in FIG. 2, the center of all those rings (which all have the same center) is at the point that has the least round trip delay 2d=T_low=L*M. This can be the spot on the earth that is closest to, for example, the satellite 10 in the example mentioned previously with respect to FIG. 1.

Each ring is supported by a dedicated ASIC at the base station. In other words, the BS may be equipped with at least N ASICs: ASIC_1, ASIC_2, . . . , ASIC_N and the ASIC_k is used to support the mobile stations in the k-th ring for k=1, 2, . . . , N in the manner described below. While this embodiment uses ASICs as the base station processing device, the present invention is applicable to the use of any processing device such as ASICs, FPGAs, DSPs, etc. or a combination thereof.

Note that the propagation delay 2d for any MS inside the k-th ring satisfies:
(L+k−1)*M<=2d<(L+k)*M (8)

However, the BS ASIC only supports 0<=2d<M in general. Therefore, this ASIC's receiver reference time is artificially skewed by (L+k−1)*M so that the round trip propagation delay seen by the ASIC is between 0 and M. This ensures that the mobile stations in the k-th ring are successfully processed by the ASIC. Note that the ASIC's transmitter reference time is not be skewed.

There are multiple ways to shift the ASIC receiver's reference time. One method is to shift the receiver's PN sequence. For example, according to one embodiment each ASIC receiver's PN sequence is shifted by (L+k−1)*M, such as according to the following expression:
PN_{—}new(t)=PN(t−(L+k−1)*M), (9)
where PN_new(t) is the new PN sequence that is a delayed version of the original PN sequence PN(t). Note that PN_new(t) may be automatically generated in the ASIC by changing the initial state of the PN code by (L+k−1)*M. View another way, the initial state of the PN code for an ASIC, denoted by PN_new(0), may be configured according to the following equation:
PN_{—}new(0)=PN(−(L+k−1)*M). (10)

Note that when a MS moves from one ring to another ring, MS processing is migrated from one ASIC to another ASIC. Since each ring may cover a distance on the order of 100˜200 kilometers, the frequency of having to migrate a MS is quite low and therefore should not incur much overhead to the overall system.

There are certain timing requirements inside the base stations and mobile station for various call processing applications. If the base station or the mobile station has not received certain messages from the other by the time limits specified by the timers inside BS and MS, it assumes some of the previous communications have failed and may take some new actions. While most of the time limits specified by those timers are quite long (i.e., above 1 second), a few of them are in the range of 500 ms to 1 second. For those specific timers, the limits may be lengthened.

Note that power control is used in general CDMA communication systems. In CDMA power control fast interactions between BS and MS with delays in the range of 1-2 microseconds are preferred. When the total propagation delay is extremely long, the power control may be turned off.

The invention being thus described, it will be obvious that the same may be varied in many ways. For example, while an example implementation of the present invention has been described with respect to a CDMA system, it will be appreciated that the present invention is applicable to other standards based systems. Such variations are not to be regarded as a departure from the invention, and all such modifications are intended to be included within the scope of the invention.

1. A method, comprising:
configuring a base station to divide a coverage area of the base station into sub-coverage areas, each sub-coverage area having a smaller range of round trip propagation delays than a range of round trip propagation delays for the coverage area of the base station.

2. The method of claim 1, wherein each sub-coverage area has a different range of round trip propagation delays.

3. The method of claim 2, wherein the different ranges of round trip propagation delays are non-overlapping.

4. The method of claim 1, wherein the configuring step assigns a different processing device of the base station to each sub-coverage area.

5. The method of claim 4, wherein each processing device includes at least one of an ASIC, FPGA and a DSP.

6. The method of claim 4, wherein each processing device includes a receiver and the configuring step skews the reference time of each receiver so that each processing device sees a different range of round trip propagation delays.

7. The method of claim 6, wherein the configuring step skews the reference time of at least one receiver by shifting a PN sequence of the receiver.

8. The method of claim 6, wherein the configuring step shifts the PN sequence of the receiver by skewing the initial PN code of the receiver.

9. The method of claim 8, wherein the different ranges of round trip propagation delays are non-overlapping.

10. The method of claim 8, wherein the sub-coverage areas are concentric.

11. The method of claim 6, wherein the range of round trip propagation delays seen by each processing device is a multiple of the range of round trip propagation delays supported by the processing device.

12. The method of claim 11, wherein the different ranges of round trip propagation delays are non-overlapping.

13. The method of claim 11, wherein the sub-coverage areas are concentric.

14. The method of claim 1, wherein the sub-coverage areas are concentric.
